(19) United States
(12) Patent Application Publication
(10) Pub. No.: US 2026/0295584 A1
(43) Pub. Date: Oct. 1, 2026

(54) User-Actuated Valve Actuator for Microfluidic Devices

(71) Applicants: Clifford Anderson, Gig Harbor, WA (US); Vi Nguyen, Phoenix, AZ (US); Jennifer Blain Christen, Chandler, AZ (US)

(72) Inventors: Clifford Anderson, Gig Harbor, WA (US); Vi Nguyen, Phoenix, AZ (US); Jennifer Blain Christen, Chandler, AZ (US)

(73) Assignee: Arizona Board of Regents on Behalf of Arizona State University, Scottsdale, AZ (US)

(21) Appl. No.: 19/631,880

(22) Filed: Mar. 27, 2026

Related U.S. Application Data
(60) Provisional application No. 63/778,661, filed on Mar. 27, 2025.
(60) Provisional application No. 63/778,665, filed on Mar. 27, 2025.

(51) Int. Cl. B01L 3/00; G01N 21/64

(52) U.S. Cl. CPC B01L 3/502715; B01L 3/502738; G01N 21/6428; G01N 21/645; B01L 2300/0816; G01N 2021/6495

(57) ABSTRACT

An apparatus includes a clip having a top extension, a bottom extension, a support connecting the top extension and the bottom extension, a channel defined by the top extension, the bottom extension, and the support, and a bump extending from the top extension into the channel. The channel is sized to receive a microfluidic cartridge. The apparatus further includes a base configured to receive the microfluidic cartridge and the clip. The bump is configured to engage a valve elastomer of the microfluidic cartridge to direct a fluid sample toward a waste reservoir when the clip is in a first position relative to the microfluidic cartridge, and toward one or more reaction chambers when the clip is in a second position relative to the microfluidic cartridge.

### CROSS-REFERENCE TO RELATED APPLICATIONS

This application claims priority to U.S. Provisional Application No. 63/778,661 and U.S. Provisional Application No. 63/778,665, both filed Mar. 27, 2025, which are each hereby incorporated by reference in its entirety.

### BACKGROUND

Point-of-care (POC) devices are diagnostic tools that enable prompt test results at or near the site of patient care, eliminating the need to send test samples to a centralized laboratory for analysis. By providing rapid results, POC devices can reduce the time between sample collection and diagnosis, allowing for faster clinical decision-making and treatment initiation. However, conventional POC devices present several challenges that limit their widespread adoption and effectiveness. Conventional POC devices can incorporate complex mechanical, electrical, or pneumatic systems for fluid handling and valve actuation, which increase manufacturing costs. Typical POC devices may also be relatively expensive due to the use of various disposable materials and the need for equipment comprising multiple components that can be expensive to service and maintain.

Accordingly, it would be beneficial to have a POC device with a valve system that minimizes or eliminates the need for complex equipment, thus enabling affordability for widespread deployment and adoption, and is user-friendly such that minimally trained personnel can operate the device with reasonable instruction.

### SUMMARY

According to one aspect of the present disclosure, an apparatus can include a clip having a top extension, a bottom extension, a support connecting the top extension and the bottom extension, a channel defined by the top extension, the bottom extension, and the support, and a bump extending from the top extension into the channel. The channel may be sized to receive a microfluidic cartridge. The apparatus can further include a base configured to receive the microfluidic cartridge and the clip. The bump may be configured to engage a valve elastomer of the microfluidic cartridge to direct a fluid sample toward a waste reservoir when the clip is in a first position relative to the microfluidic cartridge, and toward one or more reaction chambers when the clip is in a second position relative to the microfluidic cartridge.

According to one aspect of the present disclosure, a clip for use with a microfluidic cartridge can include a top extension having an outer surface, a bottom extension spaced apart from the top extension, a support connecting the top extension and the bottom extension at a first end of the clip. The top extension, the bottom extension, and the support may together define a channel having an opening at a second end of the clip opposite the first end. The channel can be sized to slidably receive the microfluidic cartridge therethrough. The clip can also include a bump extending from an inner surface of the top extension into the channel. The bump may be positioned to engage a valve elastomer of the microfluidic cartridge and depress the valve elastomer into a valve hole to selectively block fluid flow toward a waste reservoir in a first position of the clip or block fluid flow toward a reaction chamber in a second position of the clip.

According to another aspect of the present disclosure, a method of analyzing a test sample can include a test sample that is collected. A clip may be installed on a microfluidic cartridge. The clip may include a channel sized to receive the microfluidic cartridge and a bump extending into the channel. The clip can be moved to a first position relative to the microfluidic cartridge such that the bump depresses a valve elastomer of the microfluidic cartridge to block fluid flow to a reaction chamber. The test sample may be provided to the microfluidic cartridge. The test sample may be directed to the reaction chamber by moving the clip to a second position relative to the microfluidic cartridge such that the bump depresses the valve elastomer to block fluid flow to a waste reservoir. The test sample can be analyzed within the reaction chamber.

### DESCRIPTION OF THE DRAWINGS

FIG. 1 is an isometric view of a reader apparatus for use with a microfluidic cartridge.

FIG. 2 is an isometric view of an example base of the reader apparatus of FIG. 1, including a clip.

FIG. 3 is an isometric view of an example clip for use as a valve actuator for a microfluidic cartridge.

FIG. 4 is a side view of the clip of FIG. 3.

FIG. 5A is a top view of a portion of the microfluidic cartridge of FIG. 1.

FIG. 5B is a bottom view of the portion of the microfluidic cartridge of FIG. 1.

FIG. 6 is an exploded view of the microfluidic cartridge of FIG. 1.

FIG. 7A is a top-down view of a base of a reader apparatus comprising a microfluidic cartridge with a clip oriented in a first, or open position, and a corresponding cross-sectional view of the microfluidic cartridge and the clip in the open position.

FIG. 7B is a top-down view of the base of the reader apparatus comprising the microfluidic cartridge with the clip oriented in a second, or installed position, and a corresponding cross-sectional view of the microfluidic cartridge and the clip in the installed position.

FIGS. 8A and 8B are views associated with an example method of using the reader apparatus of FIG. 1.

FIG. 9 is an isometric view of a clip, according to some embodiments, in an open position on a base of a reader apparatus.

FIG. 10 is an isometric view of the clip of FIG. 9 in an installed position on the base of the reader apparatus.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from previous embodiments. Thus, present embodiments are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of disclosed embodiments. Skilled artisans will recognize the examples provided herein have many useful alternatives and fall within the scope of embodiments of this disclosure.

Some embodiments provide point-of-care devices including a reader apparatus comprising a reader and a reader base for use with a microfluidic cartridge that receives a fluid sample. A clip may be slidable along the base and may act as a user-actuated valve actuator to selectively direct the fluid sample within the microfluidic cartridge to a waste reservoir or to one or more reaction chambers. The clip can include one or more bumps that engage a depressible valve rubber of the microfluidic cartridge to open or close fluid pathways depending on the position of the clip relative to the cartridge. After the fluid sample is processed within the microfluidic cartridge, the cartridge may be inserted into the reader for sample analysis. The reader apparatus can further include a display that indicates to a user the results of the analysis, such as colored lights or other visual indicators corresponding to positive or negative detection of a target substance. Additionally, while some embodiments allow for a user to manually slide the clip into different positions, other embodiments can include pneumatic or electromechanical actuation of the sliding clip.

Accordingly, embodiments herein describe the designs, fabrication of, and methods of use for point-of-care devices such as a reader apparatus, a reader base, a clip, and/or a microfluidic cartridge. The clip can function as a low-cost valve actuator that is entirely user actuated, eliminating the need for complex mechanical, electrical, or pneumatic systems for fluid handling and valve actuation. The clip can be used by untrained personnel with minimal instruction due to detents on the clip that provide tactile feedback indicating particular valve positions. Furthermore, it should be noted that the designs and methods described herein may also be applied to point-of-care devices fabricated through other techniques.

In addition to medical diagnostics, the designs and methods described herein may also be applied to other applications that require mixing of reagents, such as environmental field testing, livestock testing, food safety monitoring, and water quality analysis. The ability to use liquid reagents and manipulate fluid flow for timing and mixing expands the type of assays that can be made portable, allowing for more sensitive assays that are based on quantitative measurements such as fluorescence. The impact potential includes allowing untrained personnel and patients to perform their own diagnostic tests at home or at the point of need, thereby expanding the range of detectable diseases and detection mechanisms that are possible outside of traditional laboratory settings.

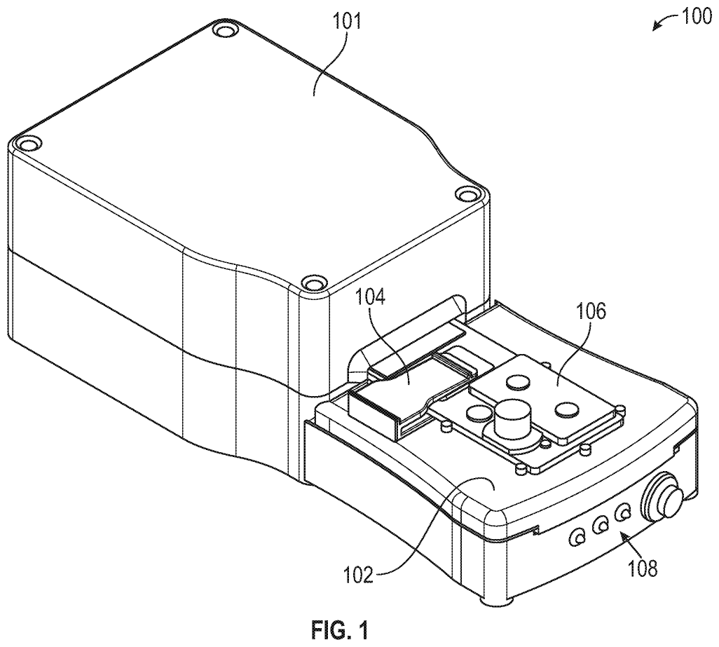

Referring now to FIG. 1, an example reader apparatus 100, according to some embodiments, is illustrated. The reader apparatus 100 includes a reader 101 and a base 102 removably coupled to the reader 101. In some embodiments, the base 102 may be slidably received within a corresponding receptacle or slot of the reader 101. In some embodiments, the base 102 may be magnetically coupled to the reader 101 using one or more magnets that provide secure attachment while permitting tool-free separation. In other embodiments, the base 102 may be snap-fit to the reader 101 using interlocking features that engage with an audible click to confirm proper seating. Additionally, the base 102 may be releasably attached to the reader 101 using latches, clips, friction-fit connections, or other mechanical fastening mechanisms that allow for repeated attachment and detachment without degradation of the coupling interface.

A clip 104 is positioned on the base 102 and is operable by a user to process a fluid sample from a patient within a microfluidic cartridge 106. The microfluidic cartridge 106 can be installed on the base 102, which can subsequently be coupled to the reader 101 to analyze the processed sample within the microfluidic cartridge 106. As will be further detailed below, processing of the sample on the microfluidic cartridge 106 can be achieved using the clip 104 that is slidably received across the microfluidic cartridge 106. The clip 104 is movable between at least two positions, including an open position (e.g., first position) and an installed position (e.g., second position), to act as a valve actuator for the microfluidic cartridge 106. In this way, the cartridge 106 can be aligned with the clip 104 via the base 102 and properly installed into the reader 101 using the base 102 and the clip 104.

The reader apparatus 100 can further include a display 108 that provides a visual indication to the user of the results of the analysis. For example, the display 108 can include colored lights or other visual indicators corresponding to positive or negative detection of a target substance, such as a red light indicating positive detection and a green light indicating negative detection. In some embodiments, the display 108 can provide alphanumeric readouts, graphical representations of test results, or quantitative measurements such as fluorescence intensity values. In other embodiments, the display 108 can be configured to provide auditory indicators, such as tones or spoken alerts, in addition to or in place of visual indicators. Furthermore, in some embodiments, the reader apparatus 100 can be configured to communicate with an external device, such as a smartphone, tablet, or computer system, via a wired connection, such as USB, Ethernet, or serial interface, or wirelessly, to transmit test results as push notifications, display detailed analysis data, or allow for remote monitoring and data logging, although other configurations are possible.

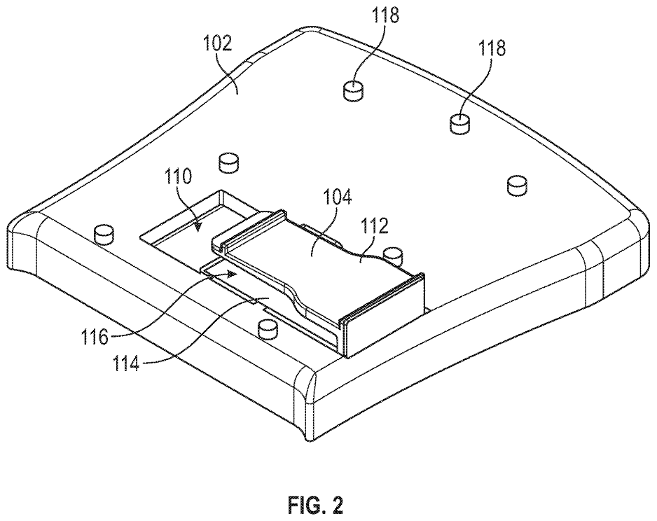

Turning now to FIG. 2, the clip 104 and the base 102 are shown. Generally, the clip 104 can be coupled to, and movable relative to, a cartridge 106 to selectively open and close fluid passageways within the cartridge 106. In particular, as will be further detailed below, the clip 104 can function as a user-actuated valve actuator that directs fluid flow by engaging depressible valve components of the cartridge 106 when positioned in different locations. The base 102 can serve to align and level the cartridge 106 when being actuated by the clip 104, ensuring proper registration between the clip 104 and the valve components of the cartridge 106. In this way, the base 102 provides a stable platform that maintains the cartridge 106 in a fixed orientation while the clip 104 is slidably adjusted to control fluid routing. Additionally, in some embodiments, the clip 104 and/or the base 102 may be reusable and configured to attach to other cartridges 106, allowing for repeated uses of the clip 104 and the base 102.

In the illustrated embodiment of FIG. 2, the clip 104 is slidably received within a corresponding depression or slot 110 of the base 102, which may thus couple the clip 104 to the base 102. In this way, the base 102 and, more specifically, the slot 110 has a profile and size that matches the clip 104, permitting the clip 104 to translate linearly along the slot 110 while maintaining alignment with the microfluidic cartridge 106. In this example, the slot 110 may include sidewalls or rails that constrain lateral movement of the clip 104, ensuring that the clip 104 travels along a predetermined path corresponding to valve positions on the cartridge 106. In other examples, the clip 104 is integrally formed with the base 102, reducing the number of separate components and simplifying assembly.

Furthermore, as shown in FIG. 2, the clip 104 can include a top extension 112 and a bottom extension 114 that creates a channel 116 that can receive and secure a microfluidic cartridge 106. The channel 116 extends between the top extension 112 and the bottom extension 114, providing a space sized to accommodate the thickness of the cartridge 106 while applying sufficient clamping force to maintain engagement between the clip 104 and the cartridge 106 during operation. To further ensure correct installment of the cartridge 106 relative to the clip 104, the base 102 can include one or more alignment pins 118 that surround the microfluidic cartridge 106 when installed. As such, the alignment pins 118 can align and guide the cartridge 106 into a proper position relative to the slot 110 and the clip 104.

In one example, the base 102 measures between about 80 millimeters to about 90 millimeters long, or between about 83 millimeters to about 86 millimeters long, or about 83 millimeters long. The base 102 can also measure in a range between about 80 millimeters to about 90 millimeters wide, or between about 79 millimeters to about 83 millimeters wide, or about 81 millimeters wide. The base 102 also measures between about 10 millimeters to about 20 millimeters high, or between about 9 millimeters to about 13 millimeters high, or about 11 millimeters high. However, in other examples, the base 102 may take on other dimensions to accommodate different cartridge sizes or applications.

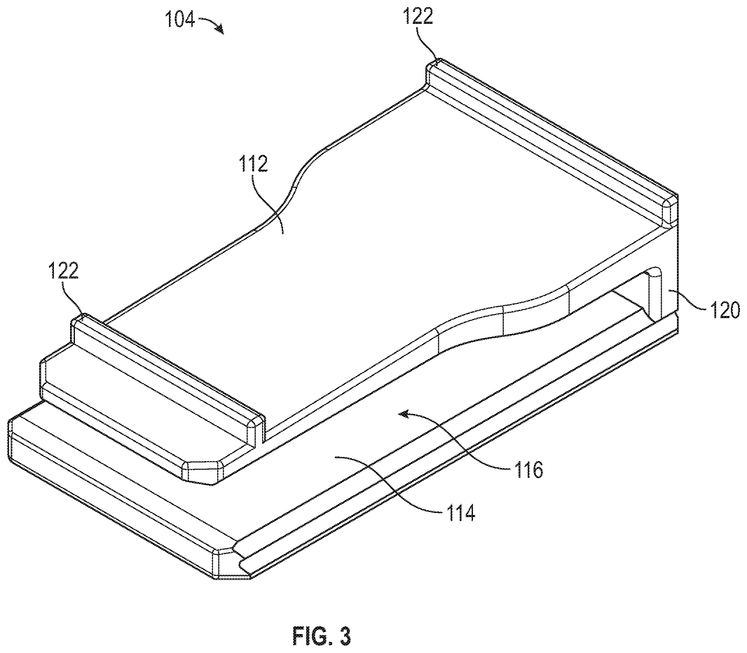

Referring now to FIG. 3, the clip 104 is shown in isolation. As shown, a support 120 connects the top extension 112 and the bottom extension 114 at one end of the clip 104. Accordingly, the top extension 112, the bottom extension 114, and the support 120 together define the channel 116 that receives the cartridge 106. In this example, the clip 104 is configured as a spring clip that uses spring tension for securing the clip 104 around the cartridge 106. The spring clip configuration allows the top extension 112 and the bottom extension 114 to flex relative to each other, allowing the channel 116 to accommodate the cartridge 106 while applying a clamping force that maintains engagement between the clip 104 and the cartridge 106 during operation. In one example, the support 120 can contact the cartridge 106 when the clip 104 is in an installed position, thus providing tactile feedback to a user indicating the position of the cartridge 106 relative to the clip 104. In some embodiments, the spring tension of the clip 104 can be adjusted by varying the material thickness or composition of the support 120 to accommodate different cartridge thicknesses or to provide varying levels of clamping force as needed for particular applications.

Additionally, in some embodiments, as shown in FIGS. 2 and 3, the top extension 112 of the clip 104 can include grips 122 or other protrusions that allow a user to easily manipulate the clip 104. The grips 122 can be configured as raised ridges, textured surfaces, or finger indentations that provide enhanced tactile engagement during operation. In some embodiments, the grips 122 can be made of the same material as the clip 104. In other embodiments, the grips 122 can be made of a rubber, silicone, or elastomeric material that is overmolded onto the top extension 112 of the clip 104, providing a softer surface that prevents slipping between a user's fingers and improves grip during wet or oily conditions that may be encountered in clinical settings. In some examples, the grips 122 may extend along a portion or the entirety of the top extension 112 to accommodate different hand sizes and gripping preferences. Accordingly, a user may press against the grips 122 to slide the clip 104 back or forward within the slot 110 of the base 102, allowing for positioning of the clip 104 relative to the microfluidic cartridge 106 with minimal effort.

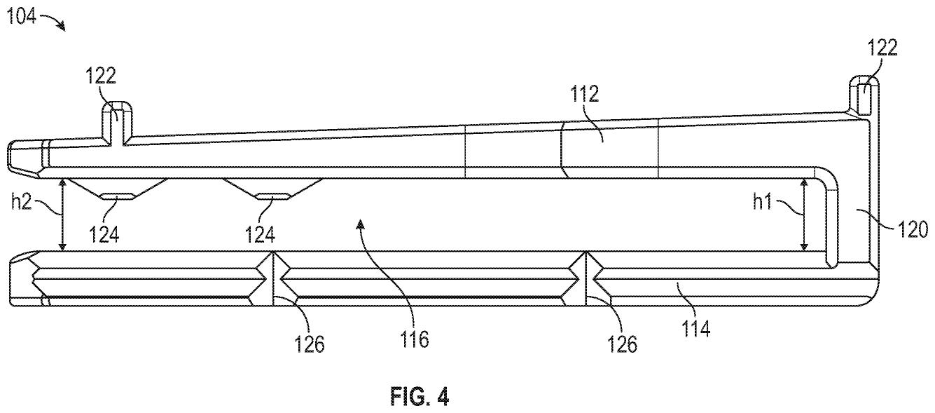

FIG. 4 shows a side view of the clip 104. As shown, the top extension 112 of the clip 104 can include one or more bumps 124 that extend into the channel 116. The bumps 124 can be positioned to align with fluid channels on the cartridge 106 and provide corresponding pressure from the clip 104 onto the cartridge 106, e.g., due to spring forces of the clip 104, effectively acting to open or close valves on the cartridge 106. In this example, two bumps 124 are shown, but more or fewer bumps can be added such that the number of bumps correspond with the number of channels or valves on the cartridge 106, allowing the clip 104 to simultaneously engage multiple valves at the same time. For instance, in embodiments where the cartridge 106 includes additional reaction chambers or fluid pathways, additional bumps 124 can be incorporated into the clip 104 to control fluid routing to each pathway independently or in combination. Thus, the clip 104 may be usable with any type of lab-on-a-chip device or cartridge 106 that contains press-actuated valves. Furthermore, in some examples, the clip 104 may be designed with a stronger spring force such that the bumps 124 are omitted.

In some embodiments, each bump 124 can be tapered such that a diameter of a proximal end of the bump 124 (connected to the top extension 112 of the clip 104) is between about 3 millimeters and about 6 millimeters, or between about 4 millimeters and about 5 millimeters, or about 4.3 millimeters. The diameter of a distal end of the bump 124 (that extends fully into the channel 116) is between about 0.5 millimeters and about 2 millimeters, or between about 0.6 millimeters and about 1.2 millimeters, or about 0.8 millimeters. In this way, the bumps 124, and the clip 104 itself, can be expanded in size by width or length that allows the clip 104 to be usable with different cartridge 106 sizes. In this example, the tapered geometry of the bumps 124 can be modified to accommodate varying valve hole dimensions, valve elastomer thicknesses, or actuation force requirements for different microfluidic cartridge configurations.

Furthermore, in some embodiments such as FIG. 4, the bottom extension 114 of the clip 104 can include one or more detents 126, e.g., extending into the bottom extension 114 of the clip 104. It should be noted that the detents 126 shown in FIG. 4 are also present in the clip 104 of FIG. 3, though they are not shown in that view. In this example, the detents 126 can engage the base 102 as the clip 104 is moved within the slot 110. In particular, the detents 126 can click into place with corresponding features of the base 102, such as recesses, grooves, or raised ridges formed in the slot 110, thus providing tactile feedback to a user to indicate a particular position of the clip 104 (e.g., installed or open). The clicking feedback tells the user when to stop sliding and makes it easy to gauge where the valve is located on the microfluidic cartridge 106 without requiring knowledge of the underlying technology. Furthermore, the detents 126 may be positioned at multiple locations along the bottom extension 114 to correspond with multiple valve positions on the cartridge 106, allowing for sequential actuation of different valves as the clip 104 is progressively moved along the slot 110. For example, they may be positioned along one side of the clip 104, as shown in FIG. 4, along an opposite side of the clip 104, or at any point therebetween.

In some embodiments, the detents 126 may be configured as spring-loaded balls, flexible tabs, or resilient protrusions that deflect when passing over intermediate positions and snap into engagement when aligned with corresponding features at designated valve positions. The force required to overcome the detent engagement can be calibrated to provide a distinct tactile sensation while still permitting smooth sliding motion between positions.

In some embodiments, the cartridge 106 itself may include embedded alignment registrations that engage with the detents 126 to provide feedback to the user to indicate a particular position of the clip 104. In such embodiments, the clip 104 may be adjusted relative to the cartridge 106 without being coupled to the base 102, allowing the clip 104 to attach directly to the cartridge 106 for standalone operation. In this configuration, a base is not needed and the clip 104 attaches directly to the microfluidic cartridge 106 using the embedded alignment registrations on the cartridge 106 itself, which provide the alignment and positioning functions that would otherwise be provided by the base 102. The clip 104 remains reusable in this embodiment and can attach to other microfluidic cartridges 106 for repeated tests.

As further shown in FIG. 4, the clip 104 and, more specifically, the channel 116 can include a height that tapers such that a first height h1 measured adjacent the support 120 is higher than a second height h2 adjacent an opening of the channel 116. This tapering height of the clip 104 can increase the pressure the clip 104 applies onto the cartridge 106 and thus can increasingly secure the cartridge 106 during installation (e.g., the height lessens from the first height h1 from the support 120 to the second height h2 adjacent the channel opening so as to provide more engagement with the cartridge 106 as the cartridge 106 is further received within the channel 116). Furthermore, the tapering height compensates for manufacturing tolerances in cartridge thickness and ensures reliable valve engagement across different cartridge batches while preventing inadvertent disengagement during fluid injection operations. With this configuration, the clip 104 can also accommodate high pressure and overflow of fluid from the cartridge 106 such that the second height h2 can be increased if too much fluid pressure is applied by the cartridge 106. That is, the clip 104 configuration allows the top extension 112 and the bottom extension 114 to flex apart when excessive fluid pressure is applied within the cartridge 106, thereby expanding the height of the channel 116. In some embodiments, when the clip 104 configuration expands in height due to excessive fluid pressure, this expansion may allow valves to open that lead to reservoirs, such as a waste reservoir, to catch overflow. This overflow safety mechanism can prevent fluid from being forced out of the cartridge 106 or causing damage to the microfluidic components during sample processing, as will be further detailed below.

In some examples, the clip 104 measures between about 30 millimeters and about 40 millimeters in length, between about 35 millimeters and about 38 millimeters in length, or about 36 millimeters in length. The clip 104 also measures between about 15 millimeters and about 25 millimeters wide, or between about 18 millimeters and about 22 millimeters wide, or about 20 millimeters wide. The clip 104 also measures between about 5 millimeters and about 10 millimeters high, or between about 6 millimeters and about 9 millimeters high, or about 7.5 millimeters high. However, in other examples, the clip 104 may take on other dimensions to accommodate different cartridge sizes or applications. For example, the clip 104 can be any size to match with microfluidic cartridge features and can expand in size by length or width to work with any microfluidic cartridge size. Additional bumps 124 may be added to accommodate any number of valves in the microfluidic cartridge 106, allowing the clip 104 to simultaneously open and close multiple valves.

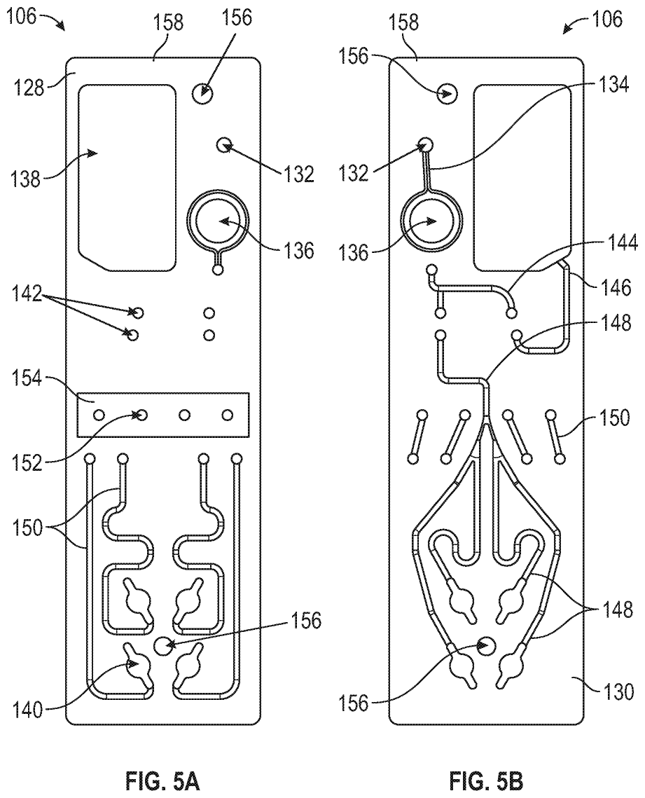

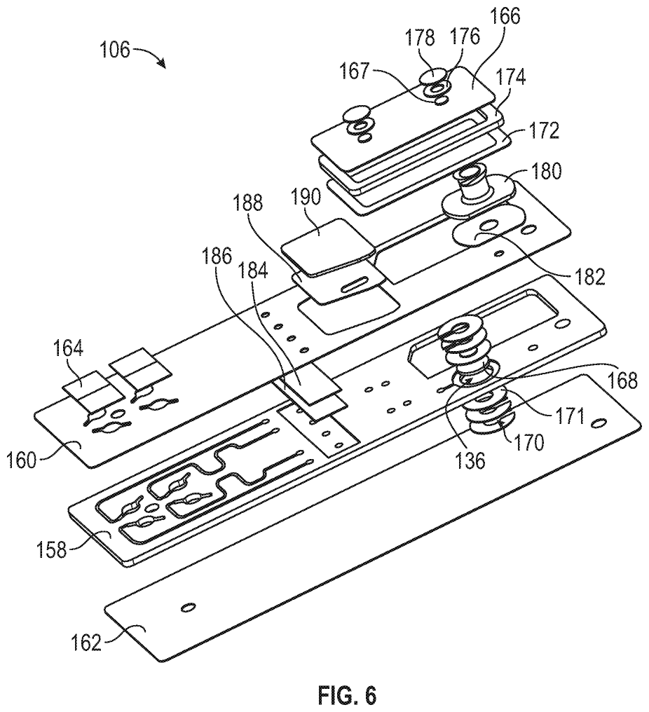

FIGS. 5A and 5B illustrate a top side 128 and a bottom side 130, respectively, of a main component 158 of the cartridge 106. As shown, the cartridge 106 can include an input hole 132 and an input channel 134 (FIG. 5B) that can receive a fluid sample from a syringe. In this example, the input hole 132 serves as the primary entry point for introducing biological samples into the cartridge 106, and is configured to interface with standard Luer lock syringes for secure, leak-free sample delivery.

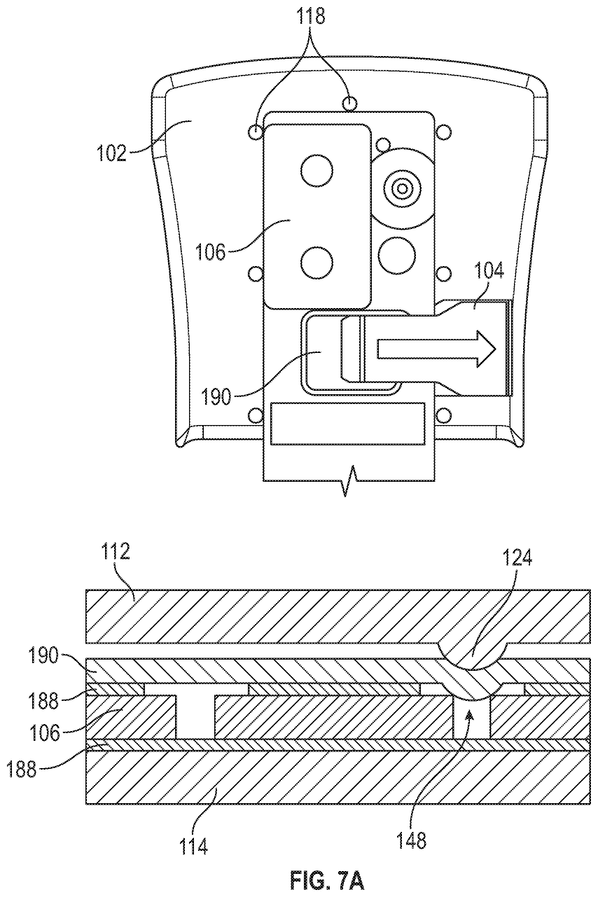

The input channel 134 fluidly connects the input hole 132 to a silica membrane cavity 136, providing a defined pathway that guides the fluid sample from the input hole 132 toward downstream processing components. In particular, the silica membrane cavity 136 can be designed to hold a silica membrane 168 (shown in FIG. 6), such as a silica matrix from a Zymo-Spin III column that filters, separates, and purifies nucleic acids in the received fluid sample, although other configurations are possible. For example, in other embodiments, the silica membrane cavity 136 can further include a silica matrix, glass fiber, magnetic beads, silica beads, or any nucleic acid binding material. In embodiments utilizing glass fiber, the binding material can provide increased surface area for nucleic acid capture, which may be advantageous for samples with low nucleic acid concentrations. In this way, the silica membrane cavity 136 collects the nucleic acid from the sample. In particular, the nucleic acid in the sample binds to the silica membrane 168, allowing for centrifuge-free, on-chip retrieval of nucleic acids. This binding mechanism relies on chaotropic salts present in the sample buffer that disrupt hydrogen bonding between water molecules and nucleic acids, promoting adsorption of the nucleic acids onto the silica surface. As such, no centrifuging is necessary for sample preparation, which simplifies the workflow and eliminates the need for laboratory equipment that would otherwise be required for conventional nucleic acid extraction protocols.

In examples where magnetic beads are used, the base 102 can include a corresponding magnet that aligns with the silica membrane cavity 136 when the cartridge 106 is installed on the base 102, such that the magnet can maintain the magnetic beads in place during fluid movement. The magnetic retention allows for sequential washing and elution steps without loss of the nucleic acid-bound beads, thereby maintaining high recovery efficiency throughout the sample preparation process.

The cartridge 106 can also include a waste reservoir 138 (FIG. 5A) and reaction chambers 140 (FIG. 5A) that a fluid sample is directed between via the clip 104. That is, the clip 104 is configured as a valve actuator, directing the fluid sample in a first direction to the waste reservoir 138 or in a second direction to the reaction chambers 140 depending on its placement relative to the cartridge 106. The waste reservoir 138 is configured to collect excess sample fluid, wash buffers, and other waste materials during sample processing, thereby preventing contamination of downstream components. Correspondingly, the reaction chambers 140 are configured to receive purified sample material for analysis and can contain pre-loaded reagents for nucleic acid amplification or other diagnostic reactions.

Furthermore, pairs of spaced-apart valve holes 142 (FIG. 5A) may be positioned to be in fluid communication or blocked from fluid communication depending on the placement of the clip 104 relative to the cartridge 106, as will be further detailed below. For example, with the clip 104 in a first position (e.g., the open position), fluid received in the input hole 132 is routed through a valve channel 144, across a first pair of valve holes 142 (e.g., traversing through the material of the main component 158 from the back to the front and the front to the back in each respective valve hole 142), and through a waste channel 146 to the waste reservoir 138.

When the clip 104 is in a second position (e.g., the installed position), fluid received in the input hole 132 can be routed through the valve channel 144, across another pair of valve holes 142, and through an inlet channel 148, which splits to the reaction chambers 140. More specifically, fluid flows from the input channel 134 through the valve channel 144 and the inlet channel 148 and to the reaction chambers 140. In this configuration, the inlet channel 148 branches into equidistant pathways so that the travel distance of a sample to each reaction chamber 140 is equal, which ensures uniform distribution of the fluid sample to each of the reaction chambers 140, and facilitates consistent reaction conditions across multiple chambers 140 for multiplexed analysis for reliable and reproducible results.

Each reaction chamber 140 can be a cavity and can include a reagent, such as lyophilized nucleic acid amplification reagents or primers for specific disease targets, with which a sample may react upon entering the reaction chamber 140 (and, as further described below, the reader 101 can be used to analyze this reaction). The reagents within each reaction chamber 140 can be pre-loaded during cartridge assembly and can be configured to detect different target sequences, allowing the cartridge 106 to be adapted for various diagnostic applications. As shown in FIGS. 5A and 5B, the cartridge 106 can include multiple reaction chambers 140, such as two, three, four, or more reaction chambers 140, allowing for multiplexing of the same sample, increasing efficiency and allowing multiple targets of one disease or multiple disease detections to occur simultaneously. This multiplexed configuration allows comprehensive diagnostic panels to be performed from a single sample input, reducing the amount of sample required and streamlining the testing workflow. However, in some embodiments, the cartridge 106 may include a single reaction chamber 140 for applications requiring detection of only one target.

Still referring to FIGS. 5A and 5B, vent channels 150 (FIG. 5A) can extend from the reaction chambers 140 to vent holes 152 located in a vent recess 154, which can help keep fluid separate from the inlet channels 148. In this example, the vent channels 150 provide a pathway for air displacement during fluid filling of the reaction chambers 140, allowing the fluid sample to completely fill each reaction chamber 140 without air pockets that could interfere with the reaction or analysis. In this way, for example, fluid leaves the reaction chambers 140, travels equidistant vent channels 150, traverses the material of the main cartridge component 158 through the vent holes 152, and may be vented at the vent recess 154. The equidistant configuration of the vent channels 150 ensures uniform pressure distribution across all reaction chambers 140, promoting consistent fluid behavior during sample processing. As further discussed below, the vent recess 154 can be located outside of the reader 101 when the cartridge 106 is inserted into the reader 101, allowing heated samples to vent to the atmosphere without affecting the optical detection components of the reader 101. Furthermore, as shown in FIGS. 5A and 5B, alignment holes 156 are used during cartridge 106 assembly for material alignment, ensuring proper registration of the various layers and components during the lamination process.

FIG. 6 shows an exploded view of the cartridge 106, including the main component 158 configured as a middle layer that is positioned between a top cover 160 and a bottom cover 162. A reaction chamber cover 164 is positioned over each respective reaction chamber 140 to seal the reaction chambers 140 and prevent contamination or evaporation of reagents during storage and operation. Correspondingly, a waste cover 166 is positioned over the waste reservoir 138 to contain waste fluids and prevent leakage during sample processing. In this way, the top cover 160, the bottom cover 162, the reaction chamber cover 164, and the waste cover 166 enclose the main component 158 of the cartridge 106 to fully contain the sample within designated cavities or channels, creating a sealed fluidic system that prevents cross-contamination between different fluid pathways and maintains sample integrity throughout the analysis process.

As shown in FIG. 6, the silica membrane cavity 136 can include a silica membrane 168 and layers of membrane rings 171 that create a membrane ring channel 170 to force fluid through the center of the silica membrane cavity 136 across the silica membrane 168 for filtering and purification of the fluid, as noted above. The membrane rings 171 are configured as annular structures that surround the silica membrane 168 and define the membrane ring channel 170 as a central passage that directs fluid flow perpendicular to the silica membrane 168 surface. This configuration ensures that the fluid sample passes uniformly through the active binding region of the silica membrane 168, maximizing contact between the nucleic acids in the sample and the silica binding surface. In this way, the membrane rings 171 and the membrane ring channel 170 ensure nucleic acid collection of the sample, rather than leaking from the sides, as in conventional designs where fluid may bypass the membrane by flowing around the edges. The membrane rings 171 can be formed from pressure sensitive adhesive materials that create a fluid-tight seal around the perimeter of the silica membrane 168, preventing lateral fluid escape and ensuring that substantially all of the sample volume is processed through the membrane. In some applications, the silica membrane cavity 136 can be made taller to accommodate more binding material for very sensitive assays that require capture of low-abundance nucleic acid targets. Additionally, in some embodiments, multiple silica membranes 168 can be stacked within the silica membrane cavity 136 to increase the total binding capacity for applications involving larger sample volumes or higher nucleic acid concentrations.

Additionally, the waste reservoir 138 is covered by a waste adhesive 172, a waste acrylic 174, the waste cover 166, a waste filter adhesive 176, and a waste filter 178. The stacked waste components allow for a higher fluid volume within the waste reservoir 138, permitting sufficient volume to accommodate excess sample fluid as well as sufficient wash fluid. This higher volume minimizes contamination, as further described below. Accordingly, the layered configuration of the waste adhesive 172, waste acrylic 174, and waste cover 166 creates an expanded cavity that increases the total holding capacity of the waste reservoir 138 beyond what would be achievable with a single-layer design. The waste filter 178, secured by the waste filter adhesive 176, prevents leakage of waste fluids and contains potentially hazardous biological materials within the waste reservoir 138. Further, in some embodiments, the waste reservoir 138 can be expanded to process higher sample volumes by increasing the thickness of the waste acrylic 174 or by adding additional acrylic layers to the stack.

A Luer adapter 180 and a Luer adhesive 182 can be positioned adjacent to the waste reservoir 138 and provide an inlet for the input hole 132. The Luer adapter 180 is configured to interface with standard Luer lock syringes, providing a secure, leak-free connection that prevents sample loss during injection. The Luer adapter 180 works with external elements, such as a syringe, as detailed below. Alternatively, in some embodiments, a sample collection tube (not shown) can be directly connected to the cartridge 106 at the input hole 132, eliminating the need for a separate syringe and simplifying the sample introduction workflow.

Still referring to FIG. 6, a vent filter 184 is received within the vent recess 154 and is secured using a vent filter adhesive 186. The vent filter 184 is configured as a hydrophobic filter that prevents fluid leakage from the cartridge 106 while permitting air to pass through during fluid filling operations. In some embodiments, the vent filter 184 may be a PTFE membrane filter with a pore size of about 0.22 μm, which provides sufficient air permeability for venting while blocking aqueous fluids from escaping the cartridge 106. In other embodiments, the vent filter 184 may comprise other hydrophobic materials such as polyvinylidene fluoride (PVDF) or polypropylene with pore sizes ranging from about 0.1 μm to about 0.5 μm depending on the application requirements.

Additionally, a valve adhesive 188 covers the main cartridge component 158 around the valve holes 142 and is protected by a flexible valve element configured as a valve elastomer or valve rubber 190 that engages the clip 104 when installed. The valve adhesive 188 can be a double-sided silicone pressure sensitive adhesive (PSA) tape, such as 90880, which provides a secure bond between the valve rubber 190 and the main component 158 while maintaining adhesion for repeated valve actuation. In some examples, the valve rubber 190 can be a 40 A durometer silicone rubber, such as 1460N11, although other configurations are possible. The 40 A durometer provides sufficient elasticity to allow the valve rubber 190 to deform into the valve holes 142 when pressed by the bump 124 of the clip 104 while also providing adequate resilience to return to its original shape when the pressure is released, thereby allowing for reliable opening and closing of the valve holes 142 during repeated actuation cycles.

The cartridge 106 can be made by a lamination process that combines the layers of materials and adhesives to form a sealed fluidic system. For example, the main component 158 of the cartridge 106 can be an injected molded acrylic, such as a polymethyl methacrylate (PMMA) or a Plexiglas V825, although other suitable thermoplastic materials such as cyclic olefin copolymer (COC), polycarbonate (PC), or polystyrene (PS) may be used depending on the application requirements. In particular, the main component 158 can be formed by injection molding such that the channels and the cavities are embedded in the top and the bottom of the main component 158, as shown in FIGS. 5A and 5B. The injection molding process allows for precise replication of microfluidic features with tight dimensional tolerances, allowing consistent fluid flow characteristics across multiple cartridges.

In some embodiments, the main component 158 can comprise a deep black coloring and no mold release to reduce the effects of autofluorescence and assay inhibition that may impact reader results. In particular, the deep black coloring absorbs stray light and minimizes background fluorescence signals that could interfere with detection of target analytes. Furthermore, the top cover 160 and/or the bottom cover 162 can be clear or transparent, allowing the reader 101 to detect fluorescence within the reaction chambers 140. In some embodiments, the transparent covers can be optically clear with low autofluorescence properties to maximize signal-to-noise ratio during fluorescence detection. In addition to fluorescence detection, the transparent covers 160, 162 can also allow for other visual detection methods, such as colorimetric detection or turbidity detection, depending on the assay requirements, although other configurations are possible.

Furthermore, the bottom cover 162, the top cover 160, the reaction chamber cover 164, the waste cover 166, the membrane rings 171, and the membrane ring channel 170 can be single-sided silicone pressure sensitive adhesives (PSA), such as 94090, although other configurations are possible. The single-sided silicone PSA tape provides a reliable bond to the main component 158 while maintaining chemical compatibility with biological samples and reagents that may contact the adhesive surfaces during operation. The vent filter adhesive 186, the waste filter adhesive 176, the waste adhesive 172, and the Luer adhesive 182 are double-sided acrylic adhesives, such as 300LSE, or 3M, although other configurations are possible. The double-sided acrylic adhesives can provide strong bonding between adjacent layers and components, ensuring a fluid-tight seal that prevents leakage during sample processing and maintains structural integrity throughout the cartridge assembly. The waste acrylic 174 can be a 3 millimeter black cast acrylic such as 8505K741, although other configurations are possible. The black coloring of the waste acrylic 174 reduces light transmission and minimizes potential optical interference with fluorescence detection in adjacent reaction chambers.

In some embodiments, a cutting plotter is used to cut the adhesives, providing precise control over adhesive layer dimensions and enabling consistent reproduction of complex shapes required for the microfluidic channels and cavities. For example, a CO₂ laser cutter can be used to cut the filters and cast acrylic, offering high precision and clean edges that minimize debris and ensure proper sealing when the layers are assembled. The laser cutting parameters, such as power and speed settings, can be adjusted based on material thickness to achieve optimal cut quality. The silicone rubber can be cut with a paper cutter, which provides a straightforward method for producing the valve rubber components with sufficient dimensional accuracy for reliable valve actuation, although other configurations such as die cutting or laser cutting are possible depending on production volume and precision requirements.

During assembly, the silica membrane cavity 136, the silica membrane 168, and the membrane ring channel 170 are assembled first. For example, the silica membrane 168 is harvested from a commercial spin column (such as a Zymo-Spin III Column, as noted above) and split in half along its height to be received within the slim cartridge 106 profile. The vent filter 184 is then applied to the vent recess 154 using the vent filter adhesive 186, creating a hydrophobic barrier that permits air displacement while preventing fluid leakage. Subsequently, the top cover 160 and the bottom cover 162 are secured to the main component 158 using a lamination process that creates a fluid-tight seal around the microfluidic channels and cavities. The reaction chambers 140 are temporarily covered with a medium tack dicing tape during initial assembly to protect the chambers from contamination and debris. This tape is later removed to insert lyophilized reagents, such as nucleic acid amplification reagents and disease-specific primers, into the reaction chambers 140, which are then permanently sealed with the reaction chamber cover 164. The reaction chamber cover 164 is configured as a single-sided silicone pressure sensitive adhesive (PSA) tape, which provides a reliable bond while maintaining chemical compatibility with the reagents contained within the reaction chambers 140, although other configurations are possible. After the reaction chamber cover 164 is secured, or, alternatively, when the reaction chambers 140 are temporarily covered with the dicing tape, the cartridge 106 is placed between aluminum plates with rubber backing and pressed using an arbor press with 2000-pound capacity to ensure adhesion. The rubber backing distributes pressure evenly across the cartridge 106 surface, preventing localized stress concentrations that could damage the microfluidic features or compromise the seal integrity.

Referring still to the assembly process, the expanded waste components are made by layering the waste acrylic 174 with the waste cover 166. Waste vent holes 167 within the waste cover 166 are further covered by the waste filter 178 adhered by the waste filter adhesive 176. The waste stack is bonded to the cartridge main component 158 using the waste adhesive 172, which provides a fluid-tight seal between the waste reservoir 138 and the main component 158. Adhesion is then ensured by placing the cartridge 106 into an arbor press, which applies uniform pressure across the bonding surfaces to eliminate air pockets and ensure complete contact between the adhesive layers. The Luer adapter 180 is made from stereolithography (SLA) 3D printing with clear resin. The Luer adapter 180 is attached to the cartridge 106 using the Luer adhesive 182 and placed in the arbor press to ensure adhesion. Furthermore, the valve rubber 190 is adhered using the valve adhesive 188 and is subsequently hand pressed. In other embodiments, the Luer adapter 180 can be injection molded as a separate part or embedded with the main cartridge component 158. The expanded waste stack can also be injection molded and embedded with the main cartridge component 158 in some embodiments.

Accordingly, in some embodiments, the cartridge 106 can have a simple design that is scalable, with a single sample inlet multiplexed to multiple reaction chambers 140. The scalable architecture allows the cartridge 106 to be adapted for different diagnostic applications by varying the number of reaction chambers 140 without requiring fundamental changes to the overall cartridge design or manufacturing process. Sample loading can also be simple with a common Luer lock syringe that interfaces with the Luer adapter 180, providing compatibility with standard laboratory equipment and eliminating the need for specialized sample introduction devices. Furthermore, the channel and valve design create unique fluid flow dynamics that allow for fluid flow to the reaction chambers 140 without requiring external pumps, pneumatic systems, or other active fluid handling mechanisms, although it should be understood that in other embodiments the clip 104 can be actuated through electrical, mechanical, or pneumatic actuation systems. In particular, the combination of the valve holes 142, the valve rubber 190, and the clip 104 allows active fluid routing controlled entirely by user actuation, reducing system complexity and cost while maintaining reliable fluid control throughout the sample processing workflow. Correspondingly, the sliding mechanism of the clip 104 allows for intuitive operation, as a user can transition between valve positions with a single linear motion rather than requiring complex multi-step manipulations. This sliding action also provides consistent and repeatable valve actuation, ensuring reliable fluid routing throughout the diagnostic process.

In some embodiments, the overall cartridge 106 can be between about 120 millimeters and about 130 millimeters long, or between about 122 millimeters and about 125 millimeters long, or about 123 millimeters long. The cartridge 106 can also be between about 30 millimeters and about 40 millimeters wide, or between about 35 millimeters or about 37 millimeters wide, or about 36 millimeters wide. The cartridge 106 can also be between about 1 millimeter or about 4 millimeters high, or between about 0.5 millimeters or about 3 millimeters high, or about 1.8 millimeters high.

The reaction chamber 140 can be between about 2 millimeters and about 8 millimeters in diameter, or between about 3 millimeters and about 5 millimeters in diameter, or about 4 millimeters. The extension features of the reaction chamber are between about 1 millimeter and about 4 millimeters long, or between about 2 millimeters and about 4 millimeters long, or about 2.5 millimeters long. When the cartridge 106 is assembled, the total volume of the reaction chamber 140 can be between about 20 μL and about 30 μL, or between about 25 μL and about 28 μL, or about 27.5 μL.

When the cartridge 106 is assembled, the waste reservoir 138 can hold between about 1 mL and about 5 mL of fluid, or between about 1.5 mL and about 3 mL of fluid, or about 1.8 mL of fluid. The waste channels 146 are between about 1 millimeter to about 4 millimeters wide, or between about 1.4 millimeters to about 3 millimeters wide, or about 1.6 millimeters wide. The waste channels 146 are between about 0.2 millimeters and about 3 millimeters high, or between about 0.5 millimeters and about 2 millimeters high, or about 0.6 millimeters high to allow for fast processing of the sample fluid.

When the cartridge 106 is assembled, the inlet channels 148 can hold between about 30 μL and about 40 μL of fluid, or between about 35 μL and about 38 μL, or about 36 μL of fluid. The inlet channels 148 can be between about 0.4 millimeters and about 2 millimeters wide, or between about 0.5 millimeters and about 1 millimeter wide, or about 0.6 millimeters wide. The inlet channels 148 can be between about 0.2 millimeters and about 1 millimeter high, or about 0.3 millimeters and about 0.8 millimeters high, or about 0.3 millimeters high.

When the cartridge 106 is assembled, the vent channels 150 can hold between about 50 μL and about 60 μL of fluid, or between about 52 μL and about 58 μL of fluid, or about 54 μL of fluid, including the vent holes 152 and the vent channels 150. The vent channels 150 can be between about 0.4 millimeters and about 2 millimeters wide, or between about 0.5 millimeters and about 1 millimeter wide, or about 0.6 millimeters wide. The vent channels 150 can be between about 0.1 millimeters and about 1 millimeter high, or about 0.2 millimeters and about 0.8 millimeters high, or about 0.2 millimeters high.

The silica membrane cavity 136 can have a diameter between about 5 millimeters and about 10 millimeters, or between about 6 millimeters and about 9 millimeters, or about 7.7 millimeters, although other configurations are possible.

The vent recess 154 can have a depth of between about 0.2 millimeters and about 2 millimeters, or between about 0.3 millimeters and about 1 millimeter, or about 0.35 millimeters to hold a vent filter 184 that prevents leakage.

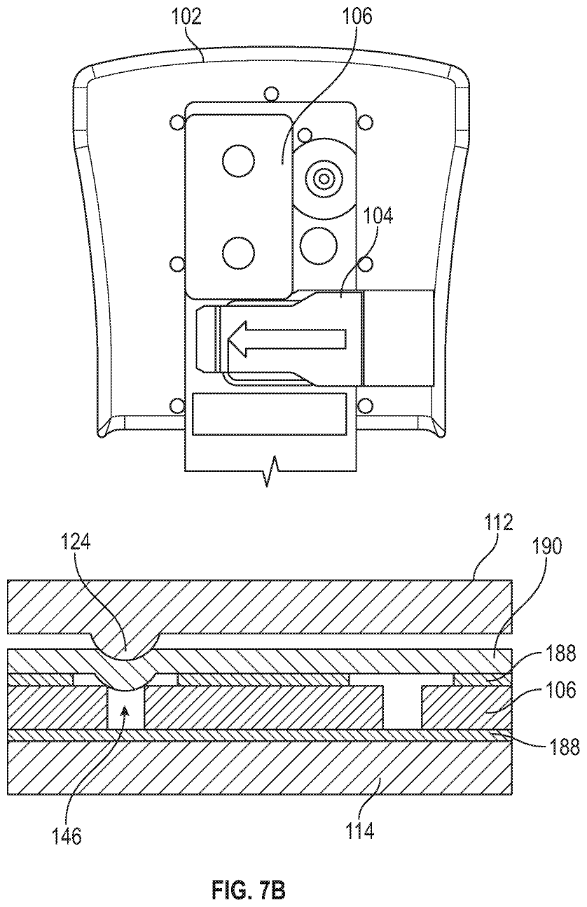

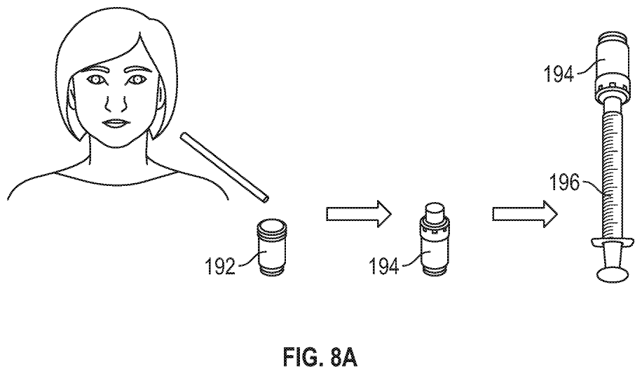

FIGS. 7A and 7B illustrate the operation of the clip 104 as a valve actuator, showing the clip 104 in the first position (e.g., the open position) and the second position (e.g., the installed position), respectively. In both positions, the cartridge 106 is received within the channel 116 of the clip 104, and the alignment pins 118 of the base 102 maintain the cartridge 106 in a level position relative to the clip 104. Accordingly, a user may adjust the position of the clip 104 by sliding the clip 104 along the slot 110 of the base 102, as discussed above.

The spring tension of the clip 104 maintains contact between the bump 124 and the valve rubber 190, ensuring consistent valve actuation throughout the sample processing workflow. The elastic nature of the valve rubber 190 allows the valve rubber 190 to deform into the valve holes 142 when engaged by the bump 124, creating a fluid-tight seal that prevents fluid from passing through the blocked valve hole 142 and directing fluid flow exclusively through the unblocked pathway. When the clip 104 is repositioned such that the bump 124 no longer aligns with a particular valve hole 142, the valve rubber 190 reverts to its original shape, allowing fluid to flow through that valve hole 142. This reversible deformation allows for repeated actuation cycles without degradation of valve performance, allowing the clip 104 to be moved between positions multiple times during a single sample processing procedure.

As shown in FIG. 7A, in the open position, the clip 104 is positioned to the right relative to the base 102 such that the bump 124 depresses the valve rubber 190 into a valve hole 142 (e.g., an elution hole) that blocks fluid flow to the inlet channel 148 and into the reaction chamber 140. In this configuration, fluid is directed toward the waste reservoir 138 through the waste channel 146 for initial sample loading and washing operations.

Conversely, as shown in FIG. 7B, in the installed position, the clip 104 is positioned to the left relative to the base 102 such that the bump 124 depresses the valve rubber 190 into a different valve hole 142 (e.g., a waste hole) that blocks fluid flow to the waste channel 146 and into the waste reservoir 138. In this configuration, fluid is directed through the inlet channel 148 toward the reaction chambers 140 for sample analysis. This reversible valve actuation mechanism similarly operates when the clip 104 is slid back to the right, redirecting fluid flow back toward the waste reservoir 138.

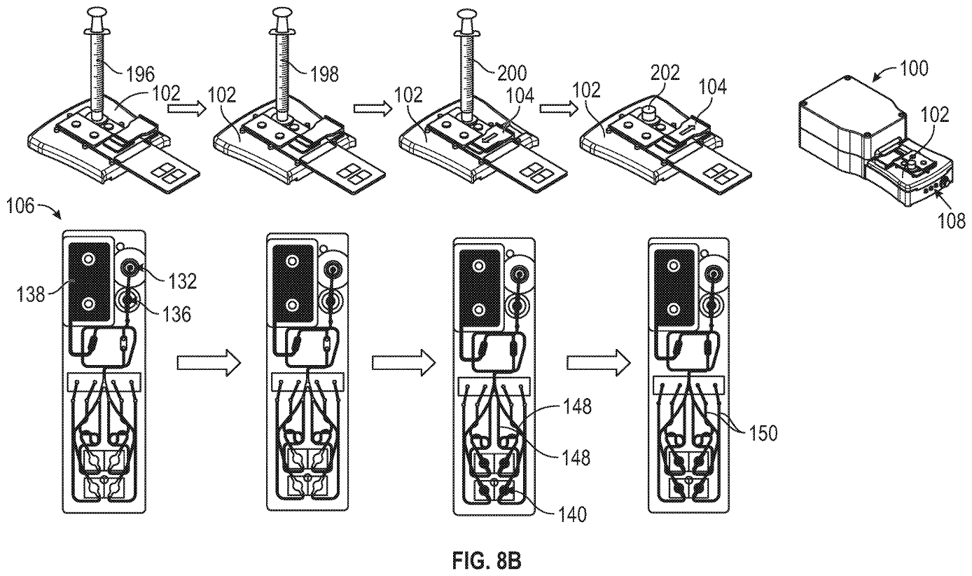

An example method of use of the reader apparatus 100 and clip 104 is shown in FIGS. 8A and 8B. For example, as shown in FIG. 8A, the method starts with collecting a sample 192 from a patient, such as saliva, cervical fluid, skin lesions, blood, urine, nasal swabs, or another biological sample. The sample 192 collected from the patient can then be heated, e.g., with proteinase K or another suitable lysis agent, to release the nucleic acids from the sample 192 and reduce the viscosity of the biofluid. The heating step facilitates cell lysis and protein digestion, which improves nucleic acid accessibility for downstream processing. In some embodiments, the heating can be performed at a temperature between about 55° C. and about 65° C. for a duration of about 10 minutes to about 20 minutes, although other temperature and time parameters may be used depending on the sample type and viscosity. There may be higher heating temperature steps to inactivate any enzymes used. After the sample 192 is heated, the heated sample 194 is placed within a sample syringe 196 that employs a Luer lock to prevent fluid leakage from the syringe during sample transfer and injection. In this example, the cartridge 106 has the Luer lock adapter 180 that interfaces with the sample syringe 196.

Referring now to FIG. 8B, the sample 192 can be processed using the cartridge 106 and the clip 104. More specifically, the cartridge 106 can be used for sample preparation, processing, and amplification. As shown, the clip 104 begins in the open position and the cartridge 106 is installed on the base 102. The sample syringe 196 is secured on the input hole 132 of the cartridge 106, where the Luer adapter 180 provides a secure, leak-free connection between the syringe and the cartridge 106. When the sample is inserted through the input hole 132, the sample travels through the input channel 134 and into the silica membrane cavity 136, where the nucleic acids in the sample bind to the silica membrane 168 due to the chaotropic salts present in the sample buffer. The remaining sample fluid, including cellular debris and other non-nucleic acid components, then flows through the valve channel 144, across the first pair of valve holes 142, and through the waste channel 146 to the waste reservoir 138.

The sample syringe 196 is removed from the input hole 132 and a wash syringe 198 is then secured on the input hole 132. Wash fluid of the wash syringe 198 flows through the input hole 132, passes through the silica membrane cavity 136, and into the waste reservoir 138, similar to the sample syringe 196, to remove contaminants, residues, salts, or excess reagents from the sample while the nucleic acids remain bound to the silica membrane 168. In this way, the wash syringe 198 washes the silica membrane cavity 136 that collects the nucleic acids from the sample, ensuring that purified nucleic acids are retained for subsequent elution and analysis.

The clip 104 is next moved to the installed position such that the valve hole 142 in fluid communication with the reaction chamber 140 is open and the valve hole 142 in fluid communication with the waste reservoir 138 is blocked. An elution syringe 200 containing an elution buffer is secured on the input hole 132 of the cartridge 106 and the elution buffer is added to release the nucleic acids from the silica membrane 168. The elution buffer disrupts the ionic interactions between the nucleic acids and the silica membrane 168, allowing the purified nucleic acids to be released into solution for downstream processing. Alternatively, in some embodiments, a blister pack can be used to deliver the elution buffer. The fluid containing the released nucleic acids then travels through the inlet channel 148 to the reaction chambers 140. As noted above, the reaction chambers 140 can be pre-loaded with lyophilized nucleic acid amplification reagents, as well as primers for different disease targets. For example, the cartridge 106 can be adapted for different disease targets by changing the target sequences embedded in the reaction chambers 140, allowing the same cartridge design to be used for multiple diagnostic applications.

The fluid then flows through the vent channels 150 and stops at the vent filter 184, which is configured as a hydrophobic membrane that permits air to escape while preventing fluid leakage, so the sample is able to vent during filling of the reaction chambers 140. The clip 104 is then moved back to the open position and the input hole 132 is blocked with a stopper 202 to seal the cartridge 106 and prevent contamination or evaporation during subsequent heating steps. The cartridge 106 and, more specifically, the reaction chambers 140 can be heated, with little migration of the reagents to prevent cross-contamination, to amplify the assay. For example, by blocking the elution valve hole 142 with the bump 124 of clip 104, backflow and fluid movement can be substantially prevented, thus limiting fluid migration during heating and ensuring that each reaction chamber 140 maintains its distinct reagent composition for accurate multiplexed detection.

The base 102 is then engaged with the reader 101 so that cartridge 106 is inserted into the reader 101, allowing the sample to be analyzed by the reader 101. In some embodiments, the reader 101 can be an electronic device that continually detects fluorescence in the reaction chamber 140 using excitation light sources and photodetectors configured to measure fluorescence intensity at predetermined wavelengths corresponding to the fluorescent labels used in the amplification reagents. The reader 101 may perform real-time monitoring of fluorescence signals during the amplification process, allowing quantitative analysis of nucleic acid concentrations in addition to qualitative positive or negative detection. Furthermore, the reader 101 can include the display 108 that provides a visual indication of analysis results to a user. In particular, as noted above, the display 108 can include colored lights or other visual indicators corresponding to positive or negative detection of a target substance, such as a red light indicating positive detection and a green light indicating negative detection. In some embodiments, the display 108 may include additional indicators such as yellow, amber, or flashing lights to indicate intermediate results, processing status, or error conditions requiring user attention. In still other embodiments, the reader apparatus 100 is connected wirelessly to a computer system to allow healthcare providers to track patient results over time and integrate diagnostic data with electronic health records.

In some applications, the total process illustrated in FIGS. 8A and 8B is estimated to take about an hour with about 20 minutes comprising the patient sample collection and about 40 minutes for the heating and amplification of the sample. In some embodiments, the sample collection time may vary depending on the sample type, with saliva samples requiring less collection time than blood or cervical fluid samples. The heating and amplification duration may also be adjusted based on the specific assay requirements and target nucleic acid sequences being detected. As shown in FIG. 8B, the procedure using the clip 104 can be a simple four-step procedure that facilitates an ease of use for a user with minimal training. The four steps include sample loading, washing, elution, and sealing, each of which is performed by attaching the appropriate syringe to the input hole 132 and adjusting the position of the clip 104 as needed. The reader apparatus 100, e.g., including the reader 101, the base 102, and the clip 104, is further reusable such that the apparatus 100 does not require cleaning between uses without the risk of contamination (e.g., because the cartridge 106 is sealed). In particular, the sealed nature of the cartridge 106 ensures that biological samples and reagents remain contained within the disposable cartridge 106, while the reader apparatus 100 components that contact the cartridge 106 exterior remain uncontaminated and ready for subsequent use with a new cartridge 106.

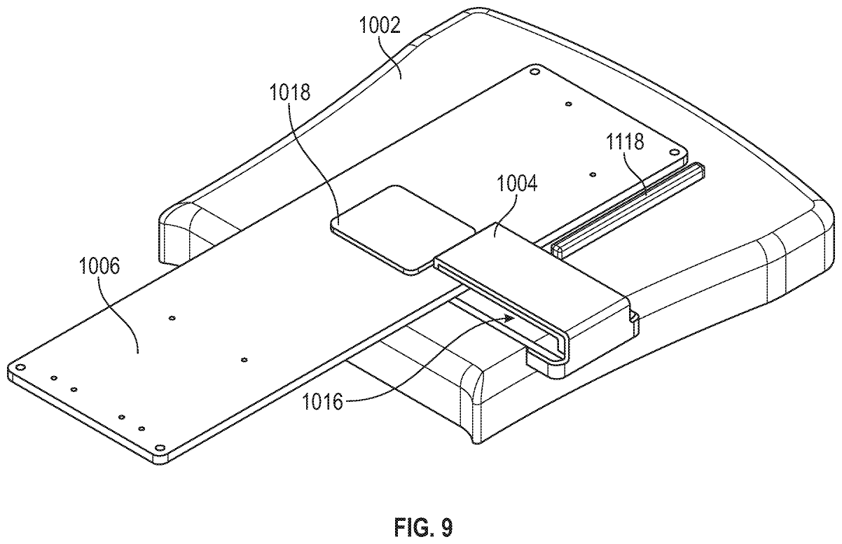

FIG. 9 illustrates another example of a clip 1004 on a base 1002. Elements illustrated in FIG. 9 that are shared with elements (i.e., structurally or functionally equivalent to) shown in FIGS. 1-8B are labeled with like reference numerals increased by 900, and discussion above applies to correspondingly numbered components below (and vice versa) in some examples, unless otherwise indicated. For example, FIG. 9 illustrates a base 1002 and a clip 1004 having a channel 1016 that receives and secures a microfluidic cartridge 1006.

As noted above, in some examples, the clip 1004 is received within the base 1002 to reduce the number of loose components of the reader apparatus. For example, in FIG. 9, the cartridge 1006 has a flexible part 1018 that selectively engages the clip 1004 between the open position and the installed position. In particular, the flexible part 1018 is configured to bend or deform when transitioning between positions, allowing the clip 1004 to selectively actuate valve components of the microfluidic cartridge 1006 without requiring the clip 1004 to be a separate component from the base 1002. In this embodiment, the clip 1004 may only block a single valve hole, such as the valve hole connected with a waste reservoir, in the installed position. This single-valve configuration simplifies the actuation mechanism while still providing directional control of fluid flow within the microfluidic cartridge 1006.

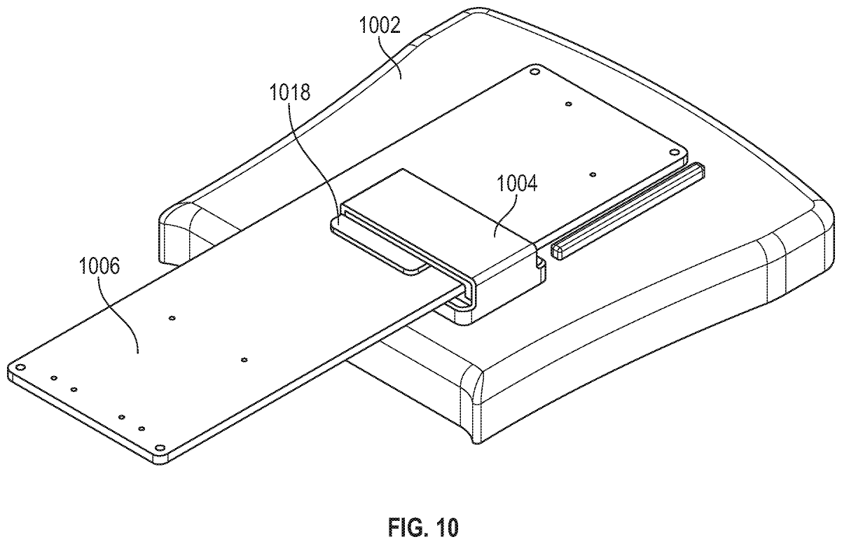

FIG. 10 illustrates the clip 1004 in the installed position. In this example, as the clip 1004 is slidably installed into the base 1002, the clip 1004 engages the flexible part 1018 such that the valve hole connected with the waste reservoir is closed. In this configuration, the flexible part 1018 applies pressure to the valve rubber (e.g., valve rubber 190 of FIGS. 1-8B) of the microfluidic cartridge 1006, depressing the valve rubber into the valve hole to create a fluid-tight seal that prevents fluid from flowing toward the waste reservoir. In this way, fluid can be directed towards a reaction chamber and is blocked from the waste reservoir, as similarly described above. In this example, the flexible part 1018 maintains consistent engagement with the valve hole throughout the sample processing workflow, ensuring reliable valve actuation without requiring separate mechanical components. Furthermore, in this embodiment, detents (not shown) of the clip 1004 provide tactile feedback and click into place when the clip 1004 engages the flexible part 1018 in the installed position, indicating to a user that the clip 1004 has reached the proper position for directing fluid to the reaction chambers.

Additionally, as shown in FIGS. 9 and 10, the base 1002 can include one or more alignment features 1118 that substantially surround or align with one or more portions of the microfluidic cartridge 1006 when installed. As such, the alignment features 1118 can align and guide the cartridge 1006 into a proper position relative to the clip 1004, ensuring proper registration between the clip 1004 and the valve components of the cartridge 1006 during operation. For example, the alignment features 1118 can include elongated protrusions that extend a length of one or more sides of the cartridge 1006 (e.g., in place of the alignment pins 118 illustrated and described above with respect to FIGS. 1-8B). In some embodiments, the alignment features 1118 can be configured as raised rails, ridges, or walls that define a receptacle sized to receive the cartridge 1006 with minimal lateral movement, thereby maintaining the cartridge 1006 in a fixed orientation while the clip 1004 is adjusted to control fluid routing. The alignment features 1118 can extend along opposing sides of the cartridge 1006 to constrain lateral movement in multiple directions, or can be positioned at corners of the cartridge 1006 to provide multi-axis alignment. In some examples, the alignment features 1118 can include tapered or chamfered surfaces that guide the cartridge 1006 into the proper position during insertion, facilitating ease of use for untrained personnel.

In light of the above, some embodiments provide a point-of-care device such as a reader apparatus that has a reader, a base, a clip, and a microfluidic cartridge that receives a test sample. The clip may act as a valve actuator that directs the fluid sample within the cartridge to a waste reservoir or a reaction chamber. The microfluidic cartridge may be inserted into the reader that analyzes the sample and displays analysis results to a user via the display. Accordingly, while other solutions require mechanical, electrical, or pneumatic methods to actuate valves and direct fluid flow, some embodiments provide a low-cost valve actuator that is entirely user actuated, so devices for lab-on-a-chip technologies do not require added costly mechanical or electrical components. The clip can work as a standalone actuator with a microfluidic cartridge, and is small and form fitting to the microfluidic cartridge. The clip can be used by untrained personnel with little instructions due to detents on the clip that give tactile feedback. Furthermore, the clip can be expanded to larger designs with more channels and multiple valve needs. The ability to manipulate liquid reagents for timing and mixing expands the type of diagnostic tests that can be made portable. The impact potential is being able to have untrained personnel and patients perform their own diagnostic tests at home or at the point of need. As such, more complex assays can be performed at the point of care, which expands the range of diseases and detection mechanisms that are possible.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. An apparatus, comprising:
a clip including a top extension, a bottom extension, a support connecting the top extension and the bottom extension, a channel defined by the top extension, the bottom extension, and the support, and a bump extending from the top extension into the channel, wherein the channel is sized to receive a microfluidic cartridge; and
a base configured to receive the microfluidic cartridge and the clip,
wherein the bump is configured to engage a valve elastomer of the microfluidic cartridge to direct a fluid sample toward a waste reservoir when the clip is in a first position relative to the microfluidic cartridge, and toward one or more reaction chambers when the clip is in a second position relative to the microfluidic cartridge.

2. The apparatus of claim 1, wherein the channel has a tapering height such that a first height measured adjacent the support is greater than a second height adjacent an opening of the channel.

3. The apparatus of claim 1, wherein the base is removably coupled to a reader configured to perform one of fluorescence detection, colorimetric detection, or turbidity detection within the one or more reaction chambers and provide a visual indication of analysis results on a display.

4. The apparatus of claim 3, wherein the reader is configured to perform real-time monitoring of fluorescence signals during an amplification process within the one or more reaction chambers.

5. The apparatus of claim 1, wherein the clip is installed directly on the microfluidic cartridge.

6. The apparatus of claim 5, wherein the base includes a slot that slidably receives the clip, the slot including sidewalls that constrain lateral movement of the clip and permit the clip to translate linearly along a predetermined path corresponding to the first position and the second position.

7. The apparatus of claim 1, wherein the top extension includes grips positioned on an outer surface to facilitate user manipulation of the clip.

8. The apparatus of claim 1, wherein the base includes one or more alignment pins positioned to surround the microfluidic cartridge when installed, the alignment pins configured to maintain the microfluidic cartridge in a fixed orientation while the clip is slidably adjusted between the first position and the second position.

9. The apparatus of claim 1, wherein the clip is configured as a spring clip, the spring clip using spring tension to apply a clamping force that maintains engagement between the bump and the valve elastomer during operation.

10. The apparatus of claim 1, wherein the bottom extension includes one or more detents configured to engage corresponding features of the base to provide tactile feedback indicating the first position or the second position of the clip.

11. The apparatus of claim 1, wherein the clip is configured to be actuated by one of a human user, a pneumatic actuator, or an electromechanical actuator to move between the first position and the second position.

12. A clip for use with a microfluidic cartridge, the clip comprising:
a top extension having an outer surface;
a bottom extension spaced apart from the top extension;
a support connecting the top extension and the bottom extension at a first end of the clip, wherein the top extension, the bottom extension, and the support together define a channel having an opening at a second end of the clip opposite the first end, the channel sized to slidably receive the microfluidic cartridge therethrough; and
a bump extending from an inner surface of the top extension into the channel, wherein the bump is positioned to engage a valve elastomer of the microfluidic cartridge and depress the valve elastomer into a valve hole to selectively block fluid flow toward a waste reservoir in a first position of the clip or block fluid flow toward a reaction chamber in a second position of the clip.

13. The clip of claim 12, wherein the bump is tapered such that a diameter of the bump connected to the inner surface of the top extension is greater than a diameter of the bump extending fully into the channel.

14. The clip of claim 12, further comprising grips positioned on the outer surface of the top extension to facilitate user manipulation of the clip.

15. The clip of claim 12, further comprising one or more detents on the bottom extension configured to engage corresponding features of a base to indicate the first position or the second position of the clip relative to the microfluidic cartridge.

16. A method of analyzing a test sample, comprising:
collecting the test sample;
installing a clip on a microfluidic cartridge, the clip including a channel sized to receive the microfluidic cartridge and a bump extending into the channel;
moving the clip to a first position relative to the microfluidic cartridge such that the bump depresses a valve elastomer of the microfluidic cartridge to block fluid flow to a reaction chamber;
providing the test sample to the microfluidic cartridge;
directing the test sample to the reaction chamber by moving the clip to a second position relative to the microfluidic cartridge such that the bump depresses the valve elastomer to block fluid flow to a waste reservoir; and
analyzing the test sample within the reaction chamber.

17. The method of claim 16, further comprising washing a silica membrane cavity of the microfluidic cartridge with a wash fluid while the clip is in the first position, wherein nucleic acids from the test sample are retained within the silica membrane cavity during washing.

18. The method of claim 17, further comprising eluting the nucleic acids from the silica membrane cavity using an elution buffer while the clip is in the second position, wherein the eluted nucleic acids are directed through an inlet channel to the reaction chamber.

19. The method of claim 16, wherein analyzing the test sample within the reaction chamber comprises inserting the microfluidic cartridge into a reader that detects fluorescence in the reaction chamber and provides a visual indication of analysis results on a display.

20. The method of claim 16, further comprising sealing an input hole of the microfluidic cartridge with a stopper after directing the test sample to the reaction chamber, wherein sealing the input hole prevents contamination and evaporation during heating of the reaction chamber.
